(19) United States
(12) Patent Application Publication
(10) Pub. No.: US 2022/0276841 A1
(43) Pub. Date: Sep. 1, 2022

(54) COMMUNICATION DATA TEXT CONFUSION ENCRYPTION METHOD

(71) Applicant: Murata Manufacturing Co., Ltd., Kyoto (JP)

(72) Inventor: Kouichirou ISHII, Kyoto (JP)

(21) Appl. No.: 17/663,252

(22) Filed: May 13, 2022

Related U.S. Application Data
(63) Continuation of application No. PCT/JP2020/039250, filed on Oct. 19, 2020.

(30) Foreign Application Priority Data
Nov. 21, 2019 (JP) 2019-210202

(51) Int. Cl. G06F 7/72; G06F 7/58; G06F 21/60

(52) U.S. Cl. CPC G06F 7/726; G06F 7/582; G06F 21/602; G06F 2207/7233

(57) ABSTRACT

Provided is a confusion encryption method for communication data text that can prevent attackers from impersonating senders. A plain text is changed to a primary communication data text by adding a one time ID. Confusion is created in the primary communication data text by using a first confusion random number. The confused primary communication data text is changed to a first modified communication data text by adding the first confusion random number. A circular shift operation is performed on the entire first modified communication data text by using a shift count based on a second confusion random number, and the first modified communication data text is then changed to a second modified communication data text by adding the second confusion random number. The second modified communication data text is changed to a communication data text by encryption.

### CROSS REFERENCE TO RELATED APPLICATION

This is a continuation of International Application No. PCT/JP2020/039250 filed on Oct. 19, 2020 which claims priority from Japanese Patent Application No. 2019-210202 filed on Nov. 21, 2019. The contents of these applications are incorporated herein by reference in their entireties.

### BACKGROUND ART

### Technical Field

The present disclosure relates to a communication data text confusion encryption method of encrypting communication data text by creating confusion in the communication data text.

To create confusion in a sequence of numerical values, for example, the technique used in the pseudorandom number generator disclosed in Patent Document 1 has been developed. In this confusion technique, of a sequence of numerical values stored in individual storage elements of a register, numerical values stored in two storage elements are exchanged to create confusion in the register. The two storage elements targeted to create confusion in the register are specified by a first address and a second address. As the first address, a primary random number generated by the pseudorandom number generator is given. As the second address, a cycle order number is given. As the cycle order number, a remainder left by dividing an order number, which indicates the order of generating a secondary random number, by the number of storage elements constituting the register is given. A numerical value stored in a storage element of the register specified by the primary random number as its address and a numerical value stored in another storage element of the register specified by the cycle order number as its address are exchanged by a control unit to create confusion in the register.

Another known technique of creating confusion in a sequence of numerical values is, for example, the technique used in the transposition table creation method disclosed in Patent Document 2. In this confusion technique, a confusion operation is performed on an input data string. The confusion operation is performed by using a remainder left by dividing random data outputted by a block cipher by the number of empty digits in a transposition table. The order number is stored in an empty digit of the numerical value indicated by this remainder in the transposition table, and this operation is repeated to create the transposition table. Numerical values of the input data string are rearranged at positions corresponding to the order numbers stored in the transposition table, and as a result, confusion is created in the input data string.
Patent Document 1: Japanese Unexamined Patent Application Publication No. 2007-287079
Patent Document 2: Japanese Unexamined Patent Application Publication No. 61-264936

### BRIEF SUMMARY

If the communication data text subjected to the confusion operation according to, for example, the known confusion technique disclosed in Patent Document 1 or 2 is intercepted, the content of the communication data text cannot be read. However, if the attacker sends the same data as a replay attack or playback attack, the attacker can impersonate the sender. In this case, even though the communication data text is encrypted, it is necessarily only to copy the cipher text and send the copied cipher text. It is thus impossible to prevent impersonation, except for the case of using encryption techniques in which the key is changed every time, such as the one-time pad.

The present disclosure provides a communication data text confusion encryption method that can inhibit impersonation as described above.

The present disclosure provides a communication data text confusion encryption method including a first step of adding a one time ID used only one time to a given position in a plain text of a given length, a second step of creating confusion, by using a first confusion random number, in a primary communication data text generated by adding the one time ID to the plain text, a third step of generating a first modified communication data text by adding the first confusion random number to an end of the confused primary communication data text, a fourth step of performing a circular shift operation on the entire first modified communication data text by using a shift count based on a second confusion random number, a fifth step of generating a second modified communication data text by adding the second confusion random number to an end of the first modified communication data text subjected to the circular shift operation, and a sixth step of generating a communication data text by encrypting the second modified communication data text.

With this configuration, the plain text is changed to the primary communication data text by adding the one time ID in the first step, and confusion is created in the primary communication data text by using the first confusion random number in the second step. The confused primary communication data text is changed to the first modified communication data text by adding the first confusion random number to the end in the third step. A circular shift operation is performed on the entire first modified communication data text by using a shift count based on the second confusion random number in the fourth step, and the first modified communication data text is then changed to the second modified communication data text by adding the second confusion random number to the end in the fifth step. The second modified communication data text is changed to the communication data text by encryption in the sixth step.

As such, the one time ID is added to the communication data text. Because the one time ID is used only one time, when a third party intercepts the communication data text and attempts to impersonate its sender by reusing the intercepted text, the text is determined as false text, and the receive side does not consider the text as true data. To address this problem, it is conceivable that the one time ID may be specified by changing and trying all kinds of one time ID. It is, however, difficult to identify the one time ID because the position of the one time ID in the communication data text is changed twice by the confusion operation using the first confusion random number and the confusion operation using the second confusion random number. To try all kinds of one time ID, it is suitable to specify by decipherment the random number at the end of the first modified communication data text and the random number at the end of the second modified communication data text to locate the one time ID in the communication data text and then try all kinds of one time ID to specify the one time ID. Otherwise, it is suitable to try all the data elements in the communication data text for the one time ID. Therefore, impersonation is difficult.

As such, the present disclosure can provide the confusion encryption method for communication data text that inhibits impersonation when an attacker attempts to impersonate a sender by sending the same data as a replay attack or playback attack.

### BRIEF DESCRIPTION OF THE DRAWINGS

FIG. 1 is a block diagram illustrating a functional configuration of hosts that communicate using a confusion encryption method for communication data text of an embodiment of the present disclosure.

FIG. 2 is a flowchart illustrating a confusion encryption process for communication data text performed by a transmit-side host in the confusion encryption method for communication data text of the embodiment of the present disclosure.

FIG. 3 is a flowchart illustrating a decryption process for communication data text encrypted in accordance with the confusion encryption method for communication data text of the embodiment of the present disclosure.

### DETAILED DESCRIPTION

The following describes an embodiment of a confusion encryption method for communication data text according to the present disclosure.

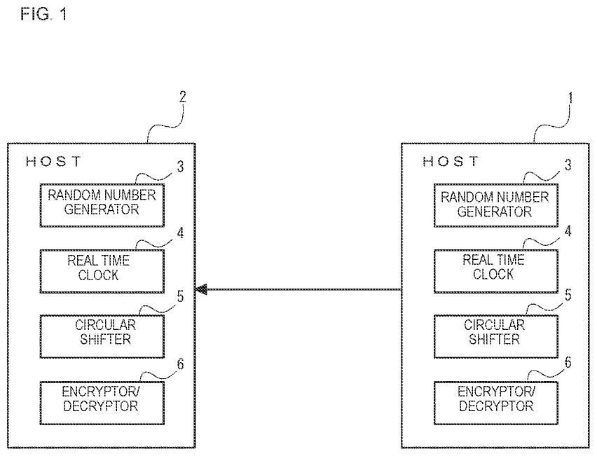

FIG. 1 is a block diagram illustrating a functional configuration of hosts (HOST1, HOST2) that communicate using a confusion encryption method for communication data text of an embodiment of the present disclosure.

HOST1 and HOST2 are, for example, personal computers (PCs) or microcomputers having the same configuration. HOST1 and HOST2 each includes a random number generator 3, a real time clock (RTC) 4, a circular shifter 5, and an encryptor/decryptor 6. HOST1 and HOST2 are each implemented as an integrated circuit (IC) module including a central processing unit (CPU), and a read-only memory (ROM) and a random-access memory (RAM).

The CPU controls individual units in accordance with computer programs stored in the ROM. The random number generator 3, the circular shifter 5, and the encryptor/decryptor 6 of HOST1 and HOST2 are implemented by software control by the CPU using the computer programs. Instead of software control by the CPU, these units may be implemented by electronic circuits as hardware. The random number generation function of the random number generator 3 may be implemented by either hardware or software. The ROM stores, in addition to computer programs, for example, operational parameters and various tables. The RAM temporarily stores, for example, parameters used for control by the CPU and is used as a storage work area.

The following is a description of the confusion encryption method for communication data text according to the embodiment that is implemented when encrypted data is transmitted from HOST1 to HOST2.

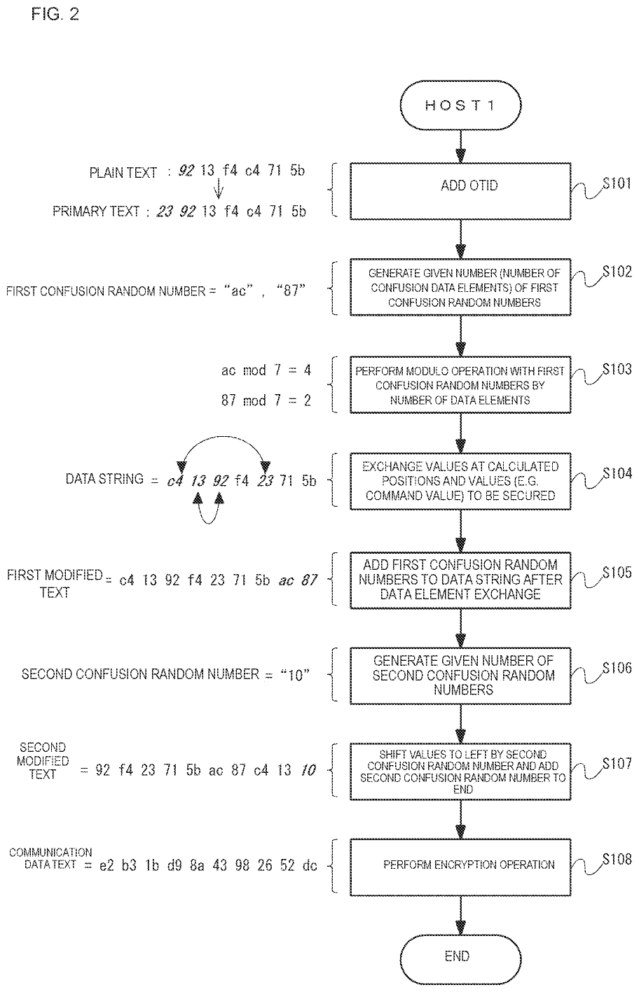

FIG. 2 is a flowchart illustrating a confusion encryption process for communication data text performed by HOST1.

Firstly, HOST1 adds a one time ID (hereinafter referred to as OTID), which is used only one time, to a given position in a given length of plain text (refer to step (hereinafter referred to as S) 101 in FIG. 2). In the present embodiment, a plain text “92 13 f4 c4 71 5b” is six bytes of given hexadecimal digits, and the beginning of the data string is a command value “92”. The CPU adds a value “23” serving as an OTID to the beginning of the plain text “92 13 f4 c4 71 5b”, so that the plain text “92 13 f4 c4 71 5b” is changed to a primary communication data text “23 92 13 f4 c4 71 5b”. As such, a primary communication data text is generated.

When a communication data text is intercepted during transmission and resent, the OTID makes the communication data text unreadable as a true communication data text. In the present embodiment, the OTID is generated based on time data measured by the real time clock 4. The OTID is, however, not necessarily generated based on the time data measured by the real time clock 4. The OTID may be generated based on a communication identification (communication ID) used in the previous communication session between HOST1 and HOST2, a hash value in a communication text in the previous communication session, a cyclic redundancy check (CRC) code value used for the cyclic redundancy check operation in digital data transmission, a total check value (checksum value) used as an error-detecting code, or a numerical value pattern at a given position in a sequence of pseudorandom numbers generated in an identical kind. In this case, HOST1 and HOST2 may include, instead of the real time clock 4, means, such as a hash calculator for calculating a hash, a CRC calculator for calculating a CRC code value, or a checksum calculator for calculating a checksum value.

After the primary communication data text “23 92 13 f4 c4 71 5b” is generated, the random number generator 3 generates a given number, which is two in this case as the number of data elements used for confusion, of first confusion random numbers “ac” and “87” to create confusion in this primary communication data text (refer to S102). In the present embodiment, the OTID “23” and the command value “92” that is a value to be secured in the plain text “92 13 f4 c4 7 1 5b” are targeted as data elements used for confusion.

Next, a modulo operation is performed with the two first confusion random numbers “ac” and “87” generated in S102 and “7” that is a data element count (the number of data elements) of the primary communication data text “23 92 13 f4 c4 71 5b” (refer to S103). Specifically, by dividing the first confusion random number “ac” (=ACh: hexadecimal number) by the data element count “7”, a remainder of 4 is left as given by the expression (ACh mod 7=4). By dividing the first confusion random number “87” (=87h: hexadecimal number) by the data element count “7”, a remainder of 2 is left as given by the expression (87h mod 7=2).

Next, the remainders of 4 and 2 obtained by the operation in S103 are determined as index values 4 and 2 that indicate particular positions of data values in the primary communication data text “23 92 13 f4 c4 71 5b”. The data elements at the particular positions specified by the index values 4 and 2 and the OTID “23” and the command value “92” to be secured, which are targeted as data elements for confusion, are exchanged (refer to S104). Specifically, as an exchange data element, the index value 4 indicates “c4” that is the fourth data element in the primary communication data text “23 92 13 f4 c4 71 5b” when the data element at the beginning is considered as the zeroth data element. The fourth data element “c4” and the zeroth data element of the OTID “23” are accordingly exchanged. As another exchange data element, the index value 2 indicates “13” that is the second data element in the primary communication data text “23 92 13 f4 c4 71 5b” when the data element at the beginning is considered as the zeroth data element. The second data element “13” and the command value “92” as the first data element are accordingly exchanged. This data exchange operation creates confusion in the primary communication data text “23 92 13 f4 c4 71 5b” in accordance with first confusion random numbers “ac” and “87”, and a data string “c4 13 92 f4 23 71 5b” is generated.

Next, the first confusion random numbers “ac” and “87” are added to the end of the confused primary communication data text, that is, the data string “c4 13 92 f4 23 71 5b” after data exchange, and as a result, a first modified communication data text “c4 13 92 f4 23 71 5b ac 87” is generated (refer to S105). Next, the random number generator 3 generates a given number of second confusion random numbers, which is “10” in the present embodiment (refer to S106).

Next, the circular shifter 5 performs a circular shift operation on the entire first modified communication data text by using a shift count (the number of shifts) based on the second confusion random number “10”, and the circular shifter 5 then adds the second confusion random number “10” to the end of the first modified communication data text subjected to the circular shift operation to generate a second modified communication data text (refer to S107). In the present embodiment, the first modified communication data text “c4 13 92 f4 23 71 5b ac 87” is shifted to the left by units of the second confusion random number “10” in bit unit, that is, 10 bits, and accordingly, a data string “92 f4 23 71 5b ac 87 c4 13” is obtained. Subsequently, the second confusion random number “10” is added to the end of the data string, so that the second modified communication data text “92 f4 23 71 5b ac 87 c4 13 10” is generated.

Although in the present embodiment the circular shifter 5 performs the circular shift operation in bit unit, the circular shifter 5 may perform the circular shift operation in byte unit. When the first modified communication data text “c4 13 92 f4 23 71 5b ac 87” is shifted to the left by 10 bytes in byte unit, a data string “c4 13 92 f4 23 71 5b ac 87” is obtained. Subsequently, the second confusion random number “10” is added to the end of the data string, so that another second modified communication data text “c4 13 92 f4 23 71 5b ac 87 10” is generated. Additionally, the shift direction in the circular shift operation is not limited to left but may be right.

After the second modified communication data text “92 f4 23 71 5b ac 87 c4 13 10” is generated, the encryptor/decryptor 6 encrypts the second modified communication data text by using a predetermined encryption key, and as a result, a communication data text “e2 b3 1b d9 8a 43 98 26 52 dc” is generated (refer to S108). The CPU of HOST1 transmits this communication data text to HOST2.

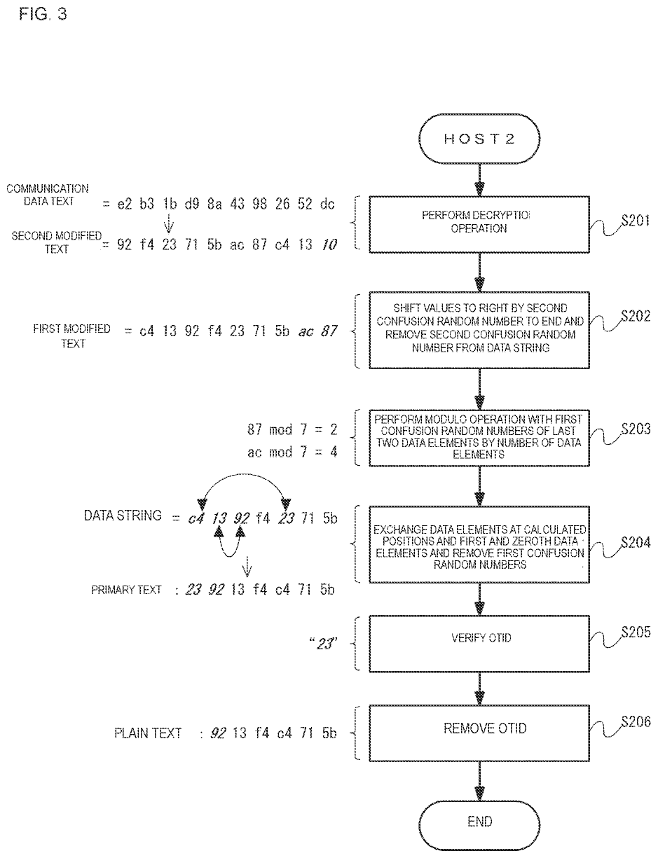

FIG. 3 is a flowchart illustrating a decryption process for the communication data text “e2 b3 1b d9 8a 43 98 26 52 dc” by HOST2 having received the communication data text.

HOST2 decrypts the communication data text in reverse order of the encryption process implemented by HOST1. Specifically, in HOST2, the encryptor/decryptor 6 firstly decrypts the received communication data text “e2 b3 1b d9 8a 43 98 26 52 dc” by using a predetermined encryption key, and as a result, the encryptor/decryptor 6 obtains the second modified communication data text “92 f4 23 71 5b ac 87 c4 13 10” (refer to S201 in FIG. 3). Because the second confusion random number “10” has been added at the end of the second modified communication data text, the CPU of HOST2 subsequently removes the second confusion random number “10” from the end of the second modified communication data text to change the second modified communication data text “92 f4 23 71 5b ac 87 c4 13 10” to a data string “92 f4 23 7 1 5b ac 87 c4 13”; and the circular shifter 5 then shifts the data string by units of the second confusion random number “10” in the direction opposite to the direction of the shift operation performed by HOST1 (refer to S202). The shift operation by HOST1 has been performed to the left by 10 bits in bit unit, a shift operation here is performed to the right by 10 bits in bit unit. This right shift operation yields the first modified communication data text “c4 13 92 f4 23 71 5b ac 87”. By this operation in S202, all the values except the values used for confusion return to the original values, and thus, the values at the end of the first modified communication data text are the added first confusion random numbers “ac” and “87”.

Next, the CPU of HOST2 performs a modulo operation with the first confusion random numbers “ac” and “87”, which are two data elements added at the end of the first modified communication data text, by the data element count “7” (refer to S203). As the result of this modulo operation, a remainder of 2 is left from the first confusion random number “87”, and a remainder of 4 is left from the first confusion random number “ac”, as described earlier.

Subsequently, the CPU of HOST2 removes the first confusion random numbers “ac” and “87” that are two data elements added at the end of the first modified communication data text and obtain the data string “c4 13 92 f4 23 71 5b”; and the CPU of HOST2 exchanges the data elements at particular positions specified by the index values of the remainders of 2 and 4 calculated by the modulo operation and the data elements of the first and zeroth index values (refer to S204). Specifically, as an exchange data element, the index value 2 indicates “92” that is the second data element in the data string “c4 13 92 f4 23 71 5b” when the data element at the beginning is considered as the zeroth data element. The second data element “92” and the data element “13” of the first index value where a command value is arranged are accordingly exchanged. As another exchange data element, the index value 4 indicates “23” that is the fourth data element in the data string “c4 13 92 f4 23 71 5b” when the data element at the beginning is considered as the zeroth data element. The fourth data element “23” and the data element “c4” of the zeroth index value where the OTID is arranged are accordingly exchanged. By this data exchange operation, the data string “c4 13 92 f4 23 71 5b” is changed back to the primary communication data text “23 92 13 f4 c4 71 5b”.

Next, the CPU of HOST2 verifies the OTID “23” at the beginning of the primary communication data text “23 92 13 f4 c4 71 5b” (refer to S205). Because in the present embodiment the time data measured by the real time clock 4 of HOST1 is used as the OTID “23”, the OTID is verified by determining whether the OTID is identical to the time data measured by the real time clock 4 of HOST2 at the time when the communication data text is transmitted. It should be noted that HOST2 previously specifies the timing when HOST1 transmits a communication data text. By verifying the OTID, HOST2 can determine whether the transmitted communication data text is data reused for impersonation or data sent by a true sender.

When the transmitted communication data text is sent by a true sender, the CPU of HOST2 subsequently removes the OTID “23” at the beginning of the primary communication data text “23 92 13 f4 c4 71 5b” (refer to S206), and as a result, the plain text “92 13 f4 c4 71 5b” is obtained.

According to this communication data text confusion encryption method of the present embodiment, as described above, the plain text “92 13 f4 c4 71 5b” is changed to the primary communication data text “23 92 13 f4 c4 71 5b” by adding the OTID “23” in S101 in FIG. 2 as a first step. Confusion is created in the primary communication data text “23 92 13 f4 c4 71 5b” by using the first confusion random numbers “ac” and “87” in S102, S103, and S104 as a second step. The confused primary communication data text is changed to the first modified communication data text “c4 13 92 f4 23 71 5b ac 87” by adding the first confusion random numbers “ac” and “87” to the end in S105 as a third step. A circular shift operation is performed on the entire first modified communication data text “c4 13 92 f4 23 71 5b ac 87” by using a shift count based on the second confusion random number “10” in S106 and S107 as a fourth step; the second confusion random number “10” is added to the end in S107 as a fifth step; and as a result, the first modified communication data text “c4 13 92 f4 23 71 5b ac 87” is changed to the second modified communication data text“92 f4 23 71 5b ac 87 c4 13 10”. The second modified communication data text “92 f4 23 71 5b ac 87 c4 13 10” is encrypted and changed to the communication data text “e2 b3 1b d9 8a 43 98 26 52 dc” in S108 as a sixth step.

As described above, according to the communication data text confusion encryption method of the present embodiment, the OTID “23” is added to the communication data text “e2 b3 1b d9 8a 43 98 26 52 dc”. Because the OTID “23” is used only one time, when a third party intercepts the communication data text “e2 b3 1b d9 8a 43 98 26 52 dc” and attempts to impersonate its sender by reusing the intercepted text, the text is determined as false text, and the receive side does not consider the text as true data. To address this problem, it is conceivable that the OTID may be specified by changing and trying all kinds of OTID. It is, however, difficult to identify the OTID “23” because the position of the OTID “23” in the communication data text “e2 b3 1b d9 8a 43 98 26 52 dc” is changed twice by the confusion operation using the first confusion random numbers “ac” and “87” and the confusion operation using the second confusion random number “10”.

To try all kinds of OTID, it is suitable to specify by decipherment the random numbers “ac” and “87”, and “10” at the end of the first modified communication data text “c 4 13 92 f4 23 71 5b ac 87” or the end of the second modified communication data text “92 f4 23 71 5b ac 87 c4 13 10” to locate the OTID “23” in the communication data text “e2 b3 1b d9 8a 43 98 26 52 dc” and then try all kinds of OTID to specify the OTID “23”. Otherwise, it is suitable to try all the data elements in the communication data text “e2 b3 1b d9 8a 43 98 26 52 dc” for the OTID “23”. Therefore, impersonation is difficult.

When the position of the OTID “23” is changed by creating confusion using the first confusion random numbers “ac” and “87”, if the decipherment operation is repeated many times to decipher the communication data text, it is possible to assume the positions of unrelocated data elements and the positions of relocated data elements in accordance with statistical data. In the present embodiment, however, another circular shift operation is also performed on the entire data by using the second confusion random number “10”, and consequently, the data elements not changing their positions in every decipherment operation are only random numbers for circular shift operation. Because values of the data elements are random numbers, although the positions of the data elements do not change, numerical values of the data elements change every time. Hence, unless the attacker decrypts the encryption method and reads the content of the communication data text, even if the attacker changes the communication data text to false values, it is possible to remove the false communication data text by verifying the OTID by HOST2 on the receive-side.

As such, the present embodiment can provide the confusion encryption method for communication data text that inhibits impersonation when an attacker attempts to impersonate a sender by sending the same data as a replay attack or playback attack.

Furthermore, in the present embodiment, the confusion operation in S102, S103, and S104 as the second step is performed by changing the positions of the two data elements of the OTID “23” and the command value “92” in the primary communication data text “23 92 13 f4 c4 71 5b” by using the first confusion random numbers “ac” and “87”.

If confusion is not created in the communication data text, when the same communication data text is transmitted, it is easy to locate the position of the OTID, and the position of a value to be secured in the plain text, such as a command value, in the communication data text. As a result, by using multiple cipher texts encrypted with the same key, it is easy to perform a ciphertext-only attack (COA) of accessing only a cipher text to be decrypted to obtain a plain text or a chosen-ciphertext attack (CCA) of obtaining a plain text from a cipher text to be decrypted under the condition that there are one or more cipher texts and one or more plain texts. To avoid this problem, confusion is created in the communication data text by using random numbers. However, if all data elements are used for confusion, it is suitable to add many data elements of random numbers. In this respect, in the present embodiment, only two values likely targeted for attacks, namely the OTID “23” and the command value “92”, are used for confusion in a fixed manner with the use of the first confusion random numbers “ac” and “87”, and a circular shift operation is then performed on the entire communication data text with the use of the second confusion random number “10” to create confusion. This can inhibit reading and use of the communication data text without necessarily decryption, while not adding many random-number data elements.

Further, in the present embodiment, the confusion operation in S104 is performed by exchanging the OTID “23” and a data element at the position of the index 4 determined by a remainder left by dividing the first confusion random number “ac” for the OTID by the data element count “7” of the primary communication data text “23 92 13 f4 c4 71 5b” and exchanging the command value “92” and a data element at the position of the index 2 determined by a remainder left by dividing the first confusion random number “87” for the command value by the data element count “7” of the primary communication data text “23 92 13 f4 c4 71 5b”. This means that in the present embodiment the OTID “23” and the command value “92” are changed with data elements at positions of indexes calculated by the modulo operation. As such, the positions for data exchange are calculated in an efficient, effective, and speedy manner by the modulo operation, which is known as an operation with simple generation algorithm, high-speed generation, and ideal statistical behavior. It is thus also possible to encrypt by confusion the communication data text in an efficient, effective, and speedy manner.

Moreover, in the present embodiment, the OTID “23” is added to the position of the zeroth index, which is a given fixed position, in the plain text “92 13 f4 c4 71 5b” in S101. The OTID “23” may be, however, added to the position of an index determined by a random number in the plain text. When the OTID “23” is added to the position of an index determined by a random number in the plain text, it is more difficult to locate the position of the OTID “23” in the communication data text.

### INDUSTRIAL APPLICABILITY

The communication data text encrypted by confusion according to the present disclosure can be communicated by using any method, such as physical protocol serial peripheral interface (SPI), universal asynchronous receiver/transmitter (UART), Inter-Integrated Circuit (I2C), Controller Area Network (CAN), ETHERNET (registered trademark), RS232C, Universal Serial Bus (USB), Bluetooth (BT) (registered trademark), or WiFi (registered trademark). The present disclosure is particularly effective when applied with ETHERNET, with which impersonation is relatively easy. Because the byte at the beginning of the communication data text is neither a command value nor padding data (synchronization data for detecting the beginning), when communication is constantly performed, it is suitable that the communication data text be communicated in accordance with a standard, such as SPI or I2C, in which the byte at the beginning can be easily located because the start of communication is predetermined by the standard.

If the waveform of the communication data text is viewed during transmission by, for example, an oscilloscope, the cipher text can be intercepted in accordance with the electrical waveform. At this time, although the communication address of USB or I2C may be read, there is no concern that addresses for control (for example, register address) are read because these addresses are secured by the communication data text confusion encryption method of the present disclosure. The communication is not necessarily performed between ICs, but may be performed between an IC and a device such as a printer.

### REFERENCE SIGNS LIST

1, 2 host (HOST)
3 random number generator
4 real time clock
5 circular shifter
6 encryptor/decryptor

1. A communication data text confusion encryption method comprising:
adding a one time identification (ID) to a given position in a plain text, the plain text being of a given length, and the one time ID being configured for one time use;
creating confusion in a primary communication data text by using a first confusion random number, the primary communication data text being generated by adding the one time ID to the plain text;
generating a first modified communication data text by adding the first confusion random number to an end of the confused primary communication data text;
performing a circular shift operation on the entire first modified communication data text by using a shift count based on a second confusion random number;
generating a second modified communication data text by adding the second confusion random number to an end of the first modified communication data text subjected to the circular shift operation; and
generating a communication data text by encrypting the second modified communication data text.

2. The communication data text confusion encryption method according to claim 1, wherein creating the confusion comprises changing, in the primary communication data text:
a position of the one time ID by using the first confusion random number, and
a position of a value secured in the plain text by using the first confusion random number.

3. The communication data text confusion encryption method according to claim 2, wherein creating the confusion further comprises:
exchanging the one time ID and a data element at a position determined by a first remainder, the first remainder being obtained by dividing the first confusion random number for the one time ID by a data element count of the primary communication data text, and
exchanging the value secured in the plain text and a data element at a position determined by a second remainder, the second remainder being obtained by dividing the first confusion random number for the secured value by the data element count.

4. The communication data text confusion encryption method according to claim 1, wherein the given position in the plain text is a given fixed position in the plain text or a position determined by a random number.

5. The communication data text confusion encryption method according to claim 2, wherein the given position in the plain text is a given fixed position in the plain text or a position determined by a random number.

6. The communication data text confusion encryption method according to claim 3, wherein the given position in the plain text is a given fixed position in the plain text or a position determined by a random number.

7. The communication data text confusion encryption method according to claim 1, wherein the one time ID is time data.

8. The communication data text confusion encryption method according to claim 1, wherein the one time ID is a communication identification used in a previous communication session.

9. The communication data text confusion encryption method according to claim 1, wherein the one time ID is a hash value in a communication text in the previous communication session.

10. The communication data text confusion encryption method according to claim 1, wherein the one time ID is a cyclic redundancy check (CRC) code value for a cyclic redundancy check operation in digital data transmission.

11. The communication data text confusion encryption method according to claim 1, wherein the one time ID is a total check value used as an error-detecting code.

12. The communication data text confusion encryption method according to claim 1, wherein the one time ID is a numerical value pattern at a given position in a sequence of pseudorandom numbers generated in an identical kind.
